(19) United States
(12) Patent Application Publication
(10) Pub. No.: US 2025/0390804 A1
(43) Pub. Date: Dec. 25, 2025

(54) PROCESS FOR ORGANIZING TOURS AND ACTIVITIES

(71) Applicant: HOLIDAY SENSES SENSATIONS LDA., LISBOA (PT)

(72) Inventor: JOSÉ HUGO OLIVEIRA LEITE, COLARES (PT)

(21) Appl. No.: 19/241,740

(22) Filed: Jun. 18, 2025

(30) Foreign Application Priority Data
Jun. 20, 2024 (EP) 24398012.5

(51) Int. Cl. G06Q 10/02; G06Q 20/40; G06Q 50/14

(52) U.S. Cl. CPC G06Q 10/025; G06Q 20/407; G06Q 50/14

(57) ABSTRACT

A Process for Auto Organizing Private Tourism Tours and Activities for two or more groups of people, that do not necessarily know themselves, but are willing to join themselves receiving benefits (either tangible and/or intangible) from it. It also makes part of this process the organization of resellers, resellers establishments, resellers staff and their customers (generically called Entities) in a way that they contribute for the successful Auto Organizing of the same Private Tours and Activities also receiving benefits from it.

### CROSS REFERENCE TO RELATED APPLICATION

This application claims the benefits of priority of European Patent Application No. 24398012.5, filed on Jun. 20, 2024, the content of which is incorporated herein by reference.

### TECHNICAL FIELD

The present application describes Technical Details and Techniques of a Process for Auto Organizing Tours and Activities that for two or more groups of people, that do not necessarily know themselves, but are willing to join together receiving benefits (either tangible and/or intangible) from it. It makes part of this application and process the organization of Resellers, Resellers Establishments, Resellers Staff and Resellers Customers (generically called Entities) in a way that they contribute as best as it can achieved to the Auto Organization of the referred Tours and Activities also receiving benefits from it.

### BACKGROUND ART

In what Tourism Tours and Activities are concerned, services are nowadays offered by the Tour Operators in two ways.

The first way is to provide a Ticket to a user, offering a Place (or a seat) in a predefined Tour or Activity that will take place if a certain minimum number of people is reached. These are normally mass-market Tours and Activities and seldom offer any differentiation or personalization. The Tour Operator finds here a way to make profit by volume of sales.

The second one is by means of Private Tours or Activities. These are the solutions where the Tour Operator offers Privacy, Intimacy, and normally also more comfort, and in certain situations, can even attend better to special requests of its customers, and is the embodiment in which the present application falls.

### SUMMARY

The present invention describes a Computer-implemented Process to organize groups of customers in private tours or activities characterized by comprising the steps of Receiving a request from a customer group to create a premium tour or activity in an area or region; Identifying entities to notify next in the creation process of such tours and activities and notify them and notify them; Determining and initiating necessary timers to facilitate the creation process; Waiting for additional customer groups to join in to meet participation thresholds; Notifying additional entities as needed so that the premium tour or activity gains sufficient participants; Determining the optimal day and time for booking the premium tour or activity; Conducting the premium tour or activity at the scheduled day and time, or if a common day and time is no longer available, notifying all parties and initiating refund processes; Calculating credits to refund in the event eventual different prices per person are paid by the different groups that joined; Notifying all involved parties of successful scheduling of the Premium Tour or Activity, and initiating refund processes as necessary.

In a proposed embodiment of present invention, the entities comprise Resellers, Resellers Establishments, Resellers Recommendation Staff, “direct” Customers and also Tour Operators using the company direct brand website, and/or Applications and/or Apps Software.

Yet in another proposed embodiment of the present invention, the area or region it comprises is a set of Geographical Area Networks, like for example, Geographical Area #1 Network and/or Geographical Area #2 Network and/or Geographical Area #3 Network up to and/or Geographical Area #n Network, where the reference #n represents an infinite number of possibilities.

Yet in another proposed embodiment of present invention, the Geographical Area Network comprises a set of Resellers, Reseller Establishments, Resellers Recommenders, Reseller Customers, Tour Operators and Area “direct” Costumers.

Yet in another proposed embodiment of present invention, the Resellers comprise at least one Reseller establishment, one Recommender from Resellers linked to Customers from Resellers and up to an infinite (#n) range of Reseller Establishments and Recommenders.

Yet in another proposed embodiment of present invention, the computer-implemented process is implemented locally and/or remotely over the Internet or over an internet network which is connected to the set of Geographical Area Networks which comprises Application Servers and/or Database Servers and/or File Servers and/or Machine Learning (ML) Recommendation System Engine(s) And Machine Learning (ML) Customer and other Entities Categorization Engine(s).

Yet in another proposed embodiment of present invention, the computer-implemented process is implemented spread up locally and/or remotely over several networks which are connected between themselves through the Internet and/or one or more internets and also connected through the Internet and/or internets to the set of Geographical Area Networks which comprises Application Servers and/or Database Servers and/or File Servers and/or Machine Learning (ML) Recommendation System Engine(s) And Customer and other Entities Categorization Engine(s).

The present invention still discloses a data processing system, characterized by comprising the physical means necessary for the execution of the computer-implemented system and computer-implemented process described in any one of the preceding paragraphs.

The present invention still discloses one or more computer programs (for example computer-programs to be stored in the servers with different purposes like Business Logic Servers, Machine Learning (ML) Engine(s) Servers, computer-programs to be stored in mobile devices like Mobile Apps or Desktop or Laptop PC Apps, etc.), characterized by comprising programming code or instructions suitable for carrying out the computer-implemented process described in any of the preceding paragraphs, in which said computer program is stored, and is executed in a data processing system, remote or in-site, for example but not limited to a single server, one or a set of load balanced pool of servers, one or more application servers farms, or any kind of distributed computing-system, performing the respective steps described in the above paragraphs.

The present invention still discloses a computer readable physical data storage device, in which the programming code or instructions of the computer program(s) are stored.

### General Description

The main goal of the present application is to disclose a methodology (a process) to Auto Organize Tours and Activities, that in nature are offered as a Private solution for a group of people that know themselves, amongst two or more groups of people that do not necessarily know themselves, but are willing to join together receiving benefits (either tangible and/or intangible) from it and benefiting from all the Comfort, Intimacy and Personal Care these kind of Tours and Activities normally offer.

The computer implemented process resorts to the use of varied computing machine types and Communication Networks at its disposal as a means of communication between all parties involved in the operationality of the procedure.

One of the goals of the developed computer implemented process is to reduce the average Cost per Person of these leisure and/or vacation Tours and Activities making them affordable to more users, and so, increasing the potential market and increase largely the benefits of the Customer and the Tour Operators seeking for a differentiated offer.

In the end, the user/Customer will benefit from a reduced cost per person, and the Tour Operators will obtain Higher Value Sales and Increase of these Sales Frequency.

In summary, the current application reveals a system and process to generate shared private tours in an area or region (amongst the software system users/Customers).

An Area, in the general concept of the current application, is a geographical tourism area. It can be related to a City, a Region centered at a given point in a map that can be defined by a frontend or a backend software application, and within a range in Kilometers (or Miles) also defined by the internal processing algorithms of the developed computer implemented process.

Considering a FIRST USE CASE where there are NO RESELLERS IN THE AREA DETERMINED BY THE USER/CUSTOMER.

The usual “direct” customer of the computer implemented process to generate groups of users for shared private tours, will chose, by means of a frontend app (whether it be a website, an application, app or any other kind of software) to create a new selection on a particular service designated by “Premium Tour or Activity” in a given tourism area which the Customer is visiting or is willing to visit.

In addition to this selection, the Customer will choose a range of dates and times or particular date and time in which he/she is willing to experience that Premium Tour or Activity, and also the occupancy (the maximum and minimum of people) the Customer finds acceptable for that matter. If the date when the creation of the new selection on a particular service is close to the first date selected for the “Premium Tour or Activity” to take place (the computer-implemented method will define how close it is according to a set of criteria defined in the Computer-implemented process), some, or all the users of the frontend app, traveling in within the same Area will then be notified based on a predefined criteria of who to notify.

The computer implemented process to generate groups of users for shared private tours enables the automatic organization of all the groups of customers that participate in that selected service “Premium Tour or Activity”, and if the minimum number of participants is reached, to ensure the event execution, the best common date and time for all groups is Set (or Booked) in the Tour Service provider (Tour Operator).

In case of the minimum number of people is not achieved by the last possible date and time determined for the Premium Tour or Activity to take place, then, all the customers that have already paid the Premium Tour or Activity are automatically refunded to their corresponding Bank Accounts.

In a SECOND USE CASE, it should be considered that THERE ARE RESELLERS IN THE AREA DETERMINED BY THE USER/CUSTOMER, and that the INITIATING RESELLER HAS ONLY ONE ESTABLISHMENT IN THAT AREA.

In the case of customers, via frontend app, choosing the resellers to Initiate or joining a Premium Tour or Activity, it is to be assumed that the mentioned customers are already physically located in said Area. The customer will then decide the dates and times he/she is willing to experience that Tour or Activity, and the occupancy (i.e., the maximum and minimum of people) he/she finds acceptable for that service.

All the reseller staff members that are registered as Tour or Activities recommenders for that reseller are notified that there is a New Premium Tour or Activity initiated in that reseller.

A given time is provided for that reseller and its Recommenders to find more groups willing to join that Premium Tour or Activity. That given time depends on several variables, one of them being the first date selected for the possibility of the Premium Tour or Activity to take place. This makes part of the developed computed implemented process, as well as the criteria to calculate the last possible date and time for a successful Premium Tour or Activity reservation (or Booking).

Within this second use case two scenarios may arise.
In a POSSIBLE SCENARIO THE RESELLER FINDS MORE GROUPS AMONGST ITS CLIENTS AND CAN CLOSE ALL PLACES IN THE PREMIUM TOUR OR ACTIVITY. The developed computer implemented process algorithms will automatically organize the groups of people/customers that participate in that Premium Tour or Activity, and if the minimum number of participants is reached the best common date and time for all groups is Reserved (or Booked) in the Tour Operator. Any refunds will be determined if applicable.
In ANOTHER SCENARIO, THE RESELLER DOES NOT FIND ENOUGH GROUPS AMONGST ITS CLIENTS TO CLOSE ALL PLACES IN THE PREMIUM TOUR OR ACTIVITY IN THE GIVEN TIME DEFINED BY COMPUTER IMPLEMENTED PROCESS. In this case, all the other resellers in that Tourism Area, along with all their staff members that registered as Tour or Activities recommenders for those resellers, are notified that there is a New Premium Tour or Activity initiated in that Tourism area. Also, some or all the “direct” users/Customers of the frontend app traveling in the Area are notified (the criteria of who to notify is defined by a developed computer implemented method). The algorithms under the computer implemented process enable to automatically organize the groups of people that participate in that Premium Tour or Activity, and if the minimum number of participants is reached the best common date and time for all groups is Reserved (or Booked) in the Tour Operator. Any refunds are calculated if applicable.
In ALL THE GIVEN CASE SCENARIOS, when the minimum number of participants for a Premium Tour or Activity is not reached by the last date and time possible for a successful reservation (or booking), the groups that have already paid are fully refunded of the amount paid to their corresponding Bank Accounts. The criteria to calculate the last possible date and time for a successful Premium Tour or Activity reservation (or Booking) is determined within the computer implemented method.

In a THIRD USE CASE, there are considered RESELLERS IN THE CHOSEN AREA AND THE INITIATING RESELLER HAS MORE THAN ONE ESTABLISHMENT IN THAT AREA.
In a POSSIBLE SCENARIO of this third use case, A RESELLER CHOOSES TO BENEFIT THE ESTABLISHMENT THAT INITIATED THE PREMIUM TOUR OR ACTIVITY. In the case of customers using resellers to Initiate or joining a Premium Tour or Activity it is assumed that those customers are already physically in that Tourism Area. So, a Customer of that Reseller Establishment “create a new Premium Tour or Activity” in that Tourism Area through the frontend app. With that the Customer decides the dates and times in which he/she is willing to experience that Tour or Activity and the occupancy (th maximum and minimum of people) he/she finds acceptable for that matter. All the reseller staff members that registered as Tour or Activities recommenders for that reseller establishment are notified that there is a New Premium Tour or Activity initiated in that reseller establishment. A given time is provided for that reseller establishment and its recommenders to find more groups willing to join that Premium Tour or Activity. That given time depends on several variables, one of them being the first date selected for the possibility of the Premium Tour or Activity to take place. The criteria to calculate the last possible date and time for a successful Premium Tour or Activity reservation (or Booking) is determined within the computer implemented method.
In ANOTHER SCENARIO, THE RESELLER ESTABLISHMENT MAY FIND MORE GROUPS AMONGST ITS CLIENTS AND CAN CLOSE ALL PLACES IN THE PREMIUM TOUR OR ACTIVITY. The computer implemented method algorithms will automatically organize the groups of people that participate in that Premium Tour or Activity, and if the minimum number of participants is reached the best common date and time for all groups is Reserved (or Booked) in the Tour Operator. Any refunds are calculated if applicable.
In ANOTHER SCENARIO, THE RESELLER ESTABLISHMENT DOES NOT FIND ENOUGH GROUPS AMONGST ITS CLIENTS THAT CAN CLOSE ALL PLACES IN THE PREMIUM TOUR OR ACTIVITY. In this case, all the other reseller establishments from that reseller in that Tourism Area, along with all their staff members that registered as Tour or Activities recommenders for those reseller establishments, are notified that there is a New Premium Tour or Activity initiated in that Tourism area. A given time is provided for those reseller establishments and its recommenders to find more groups willing to join that Premium Tour or Activity. That given time depends on several variables, one of them being the first date selected for the possibility of the Premium Tour or Activity to take place. The criteria to calculate the last possible date and time for a successful Premium Tour or Activity reservation (or Booking) is determined within the computer implemented method.
In ANOTHER SCENARIO, THE RESELLER ESTABLISHMENTS MENTIONED IN THE PREVIOUS SCENARIO DO FIND ENOUGH GROUPS AMONGST ITS CLIENTS THAT CAN CLOSE ALL PLACES IN THE PREMIUM TOUR OR ACTIVITY. The computer implemented method algorithms auto organize the groups of people that participate in that Premium Tour or Activity, and if the minimum number of participants is reached the best common date and time for all groups is Reserved (or Booked) in the Tour Operator. Any refunds are calculated if applicable.
In ANOTHER SCENARIO, THE RESELLER ESTABLISHMENTS MENTIONED PREVIOUSLY CANNOT FIND ENOUGH GROUPS AMONGST ITS CLIENTS THAT CAN CLOSE ALL PLACES IN THE PREMIUM TOUR OR ACTIVITY IN THE TIME GIVEN BY THE FRONTEND APP. In this case, all the other resellers in that Tourism Area, along with all their staff members that registered as Tour or Activities recommenders for those resellers, are notified that there is a New Premium Tour or Activity initiated in that Tourism area. Also, some or all the “direct” users/Customers of the frontend app traveling in the Area are notified (the criteria of who to notify is defined by a computer implemented method Algorithm). The computer implemented method algorithms are configured to automatically organize the groups of people that participate in that Premium Tour or Activity, and if the minimum number of participants is reached the best common date and time for all groups is Reserved (or Booked) in the Tour Operator. Any refunds are calculated if applicable.
In ANOTHER SCENARIO, THE RESELLER MENTIONED IN THE FIRST SCENARIO DOES NOT CHOOSE TO BENEFIT THE ESTABLISHMENT THAT INITIATED THE PREMIUM TOUR OR ACTIVITY. In this case, all the other reseller establishments from this late reseller in that Tourism Area, along with all their staff members that registered as Tour or Activities recommenders for those reseller establishments, are notified that there is a New Premium Tour or Activity initiated in that Tourism area. A given time is provided for those reseller establishments and its recommenders to find more groups willing to join that Premium Tour or Activity. That given time depends on several variables, one of them being the first date selected for the possibility of the Premium Tour or Activity to take place. The criteria to calculate the last possible date and time for a successful Premium Tour or Activity reservation (or Booking) makes also part of the computer implemented method algorithms.
In ANOTHER SCENARIO, THE RESELLER ESTABLISHMENTS MENTIONED IN THE PREVIOUS SCENARIO DO FIND ENOUGH GROUPS AMONGST ITS CLIENTS THAT CAN CLOSE ALL PLACES IN THE PREMIUM TOUR OR ACTIVITY. The computer implemented method algorithms auto organize the groups of people that participate in that Premium Tour or Activity, and if the minimum number of participants is reached the best common date and time for all groups is Reserved (or Booked) in the Tour Operator. Any refunds are calculated if applicable.
In ANOTHER SCENARIO, THE RESELLER ESTABLISHMENTS MENTIONED ABOVE CANNOT FIND ENOUGH GROUPS AMONGST ITS CLIENTS THAT CAN CLOSE ALL PLACES IN THE PREMIUM TOUR OR ACTIVITY IN THE TIME GIVEN BY COMPUTER IMPLEMENTED METHOD. In this case, all the other resellers in that Tourism Area, along with all their staff members that registered as Tour or Activities recommenders for those resellers, are notified that there is a New Premium Tour or Activity initiated in that Tourism area. Also, some or all the “direct” users/Customers of the frontend app traveling in the Area are notified (the criteria of who to notify is defined by a computer implemented method Algorithm). The computer method implemented algorithms are configured to automatically organize the groups of people that participate in that Premium Tour or Activity, and if the minimum number of participants is reached the best common date and time for all groups is Reserved (or Booked) in the Tour Operator. Any refunds are calculated if applicable.
For ALL THE PREVIOUS SCENARIOS, when the minimum number of participants for a Premium Tour or Activity is not reached by the last date and time possible for a successful reservation (or booking), the groups that have already paid are fully refunded of the amount paid to their corresponding Bank Accounts. The criteria to calculate the last possible date and time for a successful Premium Tour or Activity reservation (or Booking) makes part of the computer implemented method algorithms.

In a FOURTH USE CASE, THERE ARE RESELLERS IN THE AREA WORKING IN THE AREA DETERMINED BY THE USER/CUSTOMER BUT THE PREMIUM TOUR OR ACTIVITY IS INITIATED BY A CUSTOMER USING THE “DIRECT” SOFTWARE APP AND NOT BY A RESELLER CUSTOMER SOFTWARE. A customer using the “direct” frontend software app (be it its website, an application, mobile app or any other kind of software) decides to “create a new Premium Tour or Activity” in the given tourism area the Customer is visiting or willing to visit. With that, the Customer decides the dates and times in which he/she is willing to experience that Tour or Activity and the occupancy (the maximum and minimum of people) he/she finds acceptable for that matter. If the present date (date that the Tour or Activity is “created”) is close to the first date and time selected for the Premium Tour or Activity to take place (the computer-implemented software process will define what close is according to a set of criteria of its choice), some or all the “direct” users of the frontend Software app traveling in the Area are notified (the criteria of who to notify is defined by a computer implemented method Algorithm). A given time is provided for Software app to find more groups willing to join that Premium Tour or Activity. That given time depends on several variables, one of them being the first date selected for the possibility of the Premium Tour or Activity to take place. This makes part of the developed computer implemented method algorithms. The criteria to calculate the last possible date and time for a successful Premium Tour or Activity reservation (or Booking) also makes part of the computer implemented method algorithms.
In a POSSIBLE SCENARIO, ENOUGH GROUPS OF CUSTOMERS TO FILL IN ALL THE PREMIUM TOUR OR ACTIVITY PLACES ARE FOUND IN THE GIVEN TIME. The computer implemented Software Method algorithms auto organize the groups of people that participate in that Premium Tour, and if the minimum number of participants is reached the best common date and time for all groups is Reserved (or Booked) in the Tour Operator. Any refunds are calculated if applicable.
In ANOTHER SCENARIO, NOT ENOUGH GROUPS OF PEOPLE JOIN THE PREMIUM TOUR OR ACTIVITY AND ONLY SOME OF THERE SELLER ESTABLISHMENTS ARE ELIGIBLE TO BE NOTIFIED IN A FIRST PHASE. In this case, all the eligible reseller establishments in that Tourism Area, along with all their staff members that registered as Tour or Activities recommenders for those reseller establishments, are notified that there is a New Premium Tour or Activity initiated in that Tourism area. A given time is provided for those reseller establishments and its recommenders to find more groups willing to join that Premium Tour or Activity. That given time depends on several variables, one of them being the first date selected for the possibility of the Premium Tour or Activity to take place. The criteria to calculate the last possible date and time for a successful Premium Tour or Activity reservation (or Booking) makes part of the computer implemented method algorithms.
In ANOTHER SCENARIO, ENOUGH GROUPS AMONGST THE RESELLER ESTABLISHMENTS ABOVE ARE FOUND THAT CAN CLOSE ALL PLACES IN THE PREMIUM TOUR OR ACTIVITY IN THE GIVEN TIME. The computer implemented Software method algorithms auto organize the groups of people that participate in that Premium Tour or Activity, and if the minimum number of participants is reached the best common date and time for all groups is Reserved (or Booked) in the Tour Operator. Any refunds are calculated if applicable.
In ANOTHER SCENARIO, NOT ENOUGH GROUPS ARE FOUND AMONGST THE RESELLER ESTABLISHMENTS ABOVE THAT CAN CLOSE ALL PLACES IN THE PREMIUM TOUR OR ACTIVITY IN THE GIVEN TIME. In this case, all the other reseller establishments in that Tourism Area, along with all their staff members that registered as Tour or Activities recommenders for those resellers, are notified that there is a New Premium Tour or Activity initiated in that Tourism area. Enough Groups of Customers join the Premium Tour or Activity, and enough places are filled. The computer implemented Software method algorithms auto organize the groups of people that participate in that Premium Tour or Activity, and if the minimum number of participants is reached the best common date and time for all groups is Reserved (or Booked) in the Tour Operator. Any refunds are calculated if applicable.
In ANOTHER SCENARIO (A VARIANT OPTION TO THE SECOND SCENARIO), NOT ENOUGH GROUPS OF PEOPLE JOIN THE PREMIUM TOUR OR ACTIVITY AND ALL OF THE RESELLER ESTABLISHMENTS ARE ELIGIBLE TO BE NOTIFIED IN A FIRST PHASE. In this case, all the reseller establishments in that Tourism Area, along with all their staff members that registered as Tour or Activities recommenders for those reseller establishments, are notified that there is a New Premium Tour or Activity initiated in that Tourism area. The computer implemented Software method algorithms auto organize the groups of people that participate in that Premium Tour or Activity, and if the minimum number of participants is reached the best common date and time for all groups is Reserved (or Booked) in the Tour Operator. Any refunds are calculated if applicable.
NOTE FOR ALL THE PREVIOUS SCENARIOS: When the minimum number of participants for a Premium Tour or Activity is not reached by the last date and time possible for a successful reservation (or booking), the groups that have already paid are fully refunded of the amount paid to their corresponding Bank Accounts. The criteria to calculate the last possible date and time for a successful Premium Tour or Activity reservation (or Booking) makes part of the computer implemented method algorithms.

All the scenarios above can be extended with more levels of entities to be notified (“direct” customers, resellers, reseller establishments, reseller establishments staff registered as recommenders, etc.). This is, the USE CASES and SCENARIOS ABOVE do not limit the implementation of the referred process that can be further extended with USE CASES and SCENARIOS but are the necessary basis for its implementation.

Some BENEFITS FOR THE RESELLERS are now disclosed. Besides an agreed fee on each sale, each reseller will benefit from an LTV (Lifetime Value) bonus assigned to it. I.e., the Computer implemented software Process will calculate the value a Reseller brings to the developed Ecosystem, and this software process will reward a Reseller for future purchases on the company Ecosystem of a Customer introduced to the same Ecosystem by that same Reseller. That bonus is calculated according to a software algorithm and takes in accounts variables like, place of purchase (directly to website or Apps or if it is in another reseller), margin related with that service (it can be a Tour or Activity or another kind of Service as defined by the software computer implemented process algorithms), frequency that that Customer buys in the Ecosystem, frequency that all Customers acquired by that reseller buy in Ecosystem, number of Customers acquired by that reseller to the Ecosystem, any other factors not referred here that may be found of relevance.

Some BENEFITS FOR THE CUSTOMERS are now disclosed. The Customer benefits from a Premium Tour or Activity. The Customer benefits from the possibility of tailoring that Tour or Activity to his/her Group Tastes especially if the Customer is the initiator of the Premium Tour or Activity. The joining Groups of Customers also benefit from reduced cost per person and will be able to choose from more than one Premium Tour or Activity in the Area, choosing the one that best fits their tastes and pockets. No customer will pay more per a Premium Tour or Activity than the minimum Price per Person defined by the developed computer implemented software process Algorithms. If by any chance the Customer paid more than that minimum price per person at the time he/she paid the Premium Tour or Activity, when this Tour or Activity is closed and Booked, that Customer will be “rewarded” of the difference between the minimum price per person and the price per person he/she paid before the Premium Tour or Activity was closed and Booked. This price per person will depend obviously amongst other factors on the final number of people that joined that Premium Tour or Activity.

Following, some CONSIDERATIONS ON “GIVEN TIMES” (timers) are provided. The “Given Times” described on the use cases are “windows” of time related to the referred Entities involved in Joining and Booking Customer Groups to the Premium Tour or Activity to try to close as many places as they can in that same Premium Tour or Activity. In other words, the time during which it has preference for acquiring places in that Tour or Activity. These Entities can be but are not limited to, Resellers, Resellers Establishments, Resellers Recommendation Staff, “direct” Customers using the website, Applications or Apps Software and also Tour Operators. As observed in the several Use Cases there may be several layers of preference assigned either to the computer implemented Software process “direct sales” (to the “direct” end user/Customer) or to any Reseller Establishment, Reseller entity (with one or more establishments) or Group of Resellers as well as their Recommendation Staff. The algorithm to establish these timers is dynamic, and as said before, takes in consideration the first possible date and/or time for the Private Tour or Activity to take place, as well as other variables like for example but not limited to the Area the Customer is at, the speed in which more groups are joined to the premium tour, number of potential customers of a Reseller and its establishments, a direct agreement with the Reseller, number of “direct” Software app users Traveling in the Area, their traveling tastes, category or categories they fit in, and in GDPR or similar regulated areas, if the customer chose to (opt in) to be notified, etc., This computer implemented method also depends on de inputs received from Machine Learning (ML) Customer and other Entities (like Resellers, etc.) Categorization Engine(s).

Following, some CONSIDERATIONS ON “REFUNDS” are provided, and which are defined by two types.

The first type of refund is a refund when by the last date and time for a successful Booking of that Premium Tour or Activity a minimum number of people is not reached to fill in the minimum capacity defined for that Premium Tour or Activity. In this case all the Customers that have already paid that Premium Tour or Activity are refunded immediately to their respective Bank Accounts, using for that the payment method the Customer selected.

The second type of refund is more complex. After all the final places of a Premium Tour or Activity are filled in and the Tour paid and Booked, the developed computer implemented method algorithm calculates the final minimum price per person. The groups that initially submitted a payment that is more than that minimum price per person will be assigned an amount of credits in the currency paid for the Premium Tour or Activity. That amount of credits is kept in an virtual Ecosystem account or wallet, or in the customer Reseller establishment account or wallet or both, for a defined time to cover the time that the Customer is traveling in the Area. That way the customer can spend those credits in other Resellers services like for example in another Tour or Activity booking, Premium or not. Those credits can be used to discount on the price of the previously mentioned tour, or if a reseller is, for example, an Hotel, Hotel services can also be ordered and paid with those credits (like room service, Bar, SPA, Restaurant, etc.). In fact, a multitude of Use Cases for those Assigned Credits can be found. If after a given time, predetermined by the computer software algorithm, the user did not spend in any way all the assigned credits, the Customer can choose to be refunded. This refund will be done directly to the Customer's Bank Account using the payment method previously selected by the Customer.

Following, some CONSIDERATIONS ON THE DETERMINATION AND BOOKING OF THE BEST COMMON DAY AND TIME FOR ALL PREMIUM TOUR OR ACTIVITY CUSTOMERS OR CUSTOMER GROUPS THAT JOINED are provided. A very important part of this invention disclosure is the automatic calculation of the best day and time for all the groups of customers that joined the Premium Tour or Activity to experience that service. The base concept shall work in a way that the Customer that initiated the Premium Tour or Activity selects the days and times his/her group is willing to experience that service. Those days and times become defined as the days and times in which all the other groups can include themselves (in fact this can take a more complex approach, for example if the initiator of the Premium Tour or Activity leaves the attempt to form the Tour or Activity, in that case the range of days and times that the second group that has joined the Tour or Activity has selected takes preference, and so forth). All the other groups that join the Premium Tour or Activity must have at least one common day and time with the “owner” (the group that initiated) of the Premium Tour or Activity. When the conditions are met (enough people found) to Book the Premium Tour or Activity, the first common day and time for all the groups is attempted to be booked. If by any chance that day and time was meanwhile booked by someone else in the Tour Operator (either by any other Ecosystem customer or another company), the next common and available day and time is found and the Premium Tour or Activity Booked for that day and time. If by any chance the algorithm by the time of Booking finds no available possible day and time to Book despite the previous reservation of a range of days and times, all the groups will be notified of the occurrence and refunded of the amount paid to their respective Bank Accounts and using the Customer's selected payment method.

Other important concepts relate with Resellers, Reseller Establishments, Reseller or Reseller Establishments Recommenders and Reseller and Reseller Establishments Customers.

Resellers are to be defined as partners that make all or some of the Tours or Activities available in Holiday Senses Ecosystem through them using this computer implemented software process in the way Holiday Senses makes it available to them. They can be Hotel Chains, Airlines, or any other company type including companies only with digital footprint (ex: only with online sales channel) or both. Reseller Establishments are to be defined as for example an Hotel belonging to an Hotel Chain, a balcony at an Airport of an Airline Company, or any other physical or online (digital) establishment like an online Travel Agency, or any other kind of online marketplace (ex: a Tour Operator website or any Online Tourism Agency) with presence in the Tourism Geographical Area in concern.

Reseller or Reseller Establishments Recommenders are to be considered as the contact people selected by the Reseller or Establishment to address their customers and suggest our Tours and Activities. Can be a front-desk receptionist at a Hotel or a bartender, an Airline Stewardess, or any other person the Reseller or the Establishment finds relevant.

Reseller and Reseller Establishments Customers are to be considered as the Customers using the Ecosystem Software that comes directly from the contact with a Reseller Establishment or its Recommenders.

### BRIEF DESCRIPTION OF THE DRAWINGS

For better understanding of the present application, figures representing preferred embodiments are herein attached which, however, are not intended to limit the process disclosed herein.

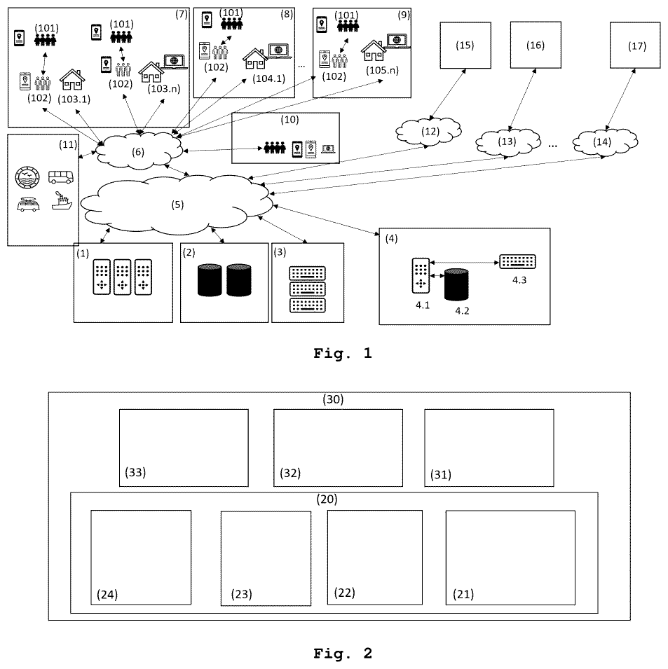

FIG. 1—discloses a possible embodiment of the overall structure and data exchange flow of the current invention, where the reference numbers relate to:
1—Application Servers—may comprise at least one server machine and may be composed of more sets of server computing machines (for example in one or more sets load balanced pool(s) of servers or server farms);
2—Database Server(s);
3—File Server(s);
4—Machine Learning (ML) Recommendation System, Customer Categorization and Other Entities Categorization Engine(s);
4.1—Application Server(s), also as described in 1;
4.2—DB Server(s);
4.3—File Server(s);
5—Network;
6—Geographical Area #1 Network;
7—Reseller #1 in Geographical Area #1;
8—Reseller #2 in Geographical Area #1;
9—Reseller #n in Geographical Area #1;
10—Area #1 Customers using the “direct” front-end software;
11—Tour operators using the back-end software;
12—Geographical Area #2 Network;
13—Geographical Area #3 Network;
14—Geographical Area #n Network;
15—Geographical Area #2 Network Resellers, Reseller Establishments, Resellers Customers, “direct” Customers and Tour Operators;
16—Geographical Area #3 Network Resellers, Reseller Establishments, Resellers Customers, “direct” Customers and Tour Operators;
17—Geographical Area #n Network Resellers, Reseller Establishments, Resellers Customers, “direct” Customers and Tour Operators;
101—Customers from Resellers;
102—Recommenders from Resellers;
103.1—Geographical Area #1 Reseller #1 Establishment #1;
103.n—Geographical Area #1 Reseller #1 Establishment #n;
104.1—Geographical Area #1 Reseller #2 Establishment #1;
105.n—Geographical Area #1 Reseller #n Establishment #n;

FIG. 2—discloses a possible embodiment of the functional layers of the current invention, where the reference numbers relate to:
20—Layer 1;
21—Machine Learning Customer and Other Entities Categorization Engine(s);
22—Timers (Given Times) Calculation Module;
23—Entities (Resellers, Reseller Establishments, Resellers Staff, Direct Customers, Tour Operators) Notification Determination Module;
24—Software Module that Calculate the Last Possible Date and Time and the Best Common Date and Time that a Premium Tour or Activity can Take Place;
30—Layer 2;
31—Premium Tour or Activity Groups Auto-Organizing Software Module;
32—Premium Tour or Activity Auto-Booking Module;
33—Entities Benefits Calculation and Attribution Module;

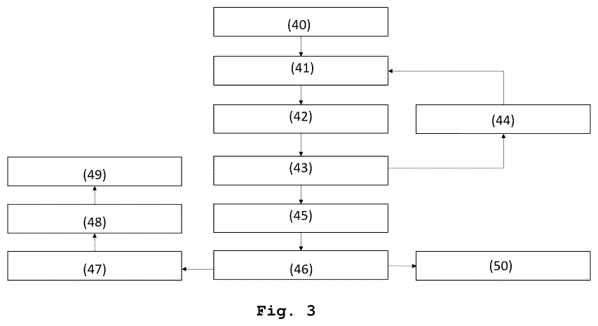

FIG. 3—discloses a possible embodiment of the workflow of the current invention, where the reference numbers relate to:
40—Creation of a Premium Tour or Activity by a Customer Group;
41—Identification of what Entities to Notify Next and Notify Them;
42—Determination and Starting of the Necessary Timers;
43—Waiting for More Customer Groups to Join In;
44—Its Necessary to Notify More Entities;
45—Premium Tour or Activity Has Enough Customers;
46—Determine Best Day and Time to Book;
47—Best Day and Time found, Premium Tour is Booked;
48—Calculate Credits to Refund and Reseller(s) benefits;
49—Notify All Parties;
50—A Common Day is no Longer Available Notify All Parties and Refund.

### DESCRIPTION OF EMBODIMENTS

With reference to the figures, some embodiments are now described in more detail, which are however not intended to limit the scope of the present application.

As described before, in the field of Tourism Tours and Activities, a rising need as emerged for Auto Organizing Tours and Activities that in nature are offered as Private (for a group of people that know themselves) amongst two or more groups of people that use the computer implemented software process (either directly or in the form provided to resellers) and that do not necessarily know themselves, but are willing to join together receiving benefits (either tangible and/or intangible) from it and benefiting from all the Comfort, Intimacy and Personal Care, these kind of Tours and Activities normally offer.

Tourism Agencies up to the present date only offer conventional Ticket Based Tours or Activities and/or Private Tours or Activities not taking full advantage of what Private Tours and Activities can offer. The result is the focus on Ticket Based Tours and Activities and seldom selling Private Tours and Activities, especially if they are of a higher quality and therefore price.

This contrasts with the solution herein disclosed, and which resorts to a computer implemented Software Process Implemented using varied computing machine types and uses the Communication Networks at its disposal as a means of communication between all parties involved.

The main goal of the current application is to provide a computer programable software Process, that enables the reduction of the average Cost per Person of these Tours and Activities making them affordable to more pockets and so increasing the potential market for them and benefits largely either the Customer that consumes the Tours and Activities and the Tour Operators seeking for a differentiated offer and higher sales and profits. In other words, the Customers benefit from a reduced cost per person, an increased Tour or Activity quality and the Tour Operators benefit from Higher Value Sales and Increase of these Sales Frequency. On the other hand, whenever one or more Resellers are involved, these also highly benefit from this technology and working process, through Lifetime Value benefits, ability to cross-sell other products they may have to the Customer and of course a direct gain of these sales, both for the establishment and their staff.

As previously mentioned, FIG. 1 discloses a possible embodiment of the overall structure and data exchange flow of the current invention.

In a proposed embodiment of the invention, the method to organize groups of customers in private tours or activities is implemented over a local or remote global communications network(s) (5) which might be connected to Application Servers (1) and/or Database Servers (2) and/or File Servers (3) and/or Machine Learning Recommendation Engine(S) and/or Machine Learning Customer and Other Entities Categorization Engine(s) (4) (also a sort of Recommendation Engine(s)). This global communications network (5) may also ensure data exchange between several Geographical Area Networks, like for example, Geographical Area #1 Network (6) and/or Geographical Area #2 Network (12) and/or Geographical Area #3 Network (13) and/or Geographical Area #n Network (14), where the reference #n represents an infinite number of possibilities.

In one embodiment of the invention, the several Geographical Area Networks are linked to Geographical Area Network Resellers, Customers and Tour Operators, particularly, Geographical Area #2 Network (12) exchanges data with Geographical Area #2 Network Resellers, Customers and Tour Operators (15), Geographical Area #3 Network (12) exchanges data with Geographical Area #3 Network Resellers, Customers and Tour Operators (16), and Geographical Area #n Network (14) exchanges data with Geographical Area #n Network Resellers, Customers and Tour Operators (17).

In one embodiment of the invention, the Geographical Area #1 Network may ensure data exchange between Tour operators (11) and a set of Resellers, like for example, a Reseller #1 (7), a Reseller #2 (8) and a Reseller #n (9). The Geographical Area #1 Network also ensures data exchange with Area #1 “direct” Customers (10).

In one embodiment of the invention, Reseller #1 (7) comprises a set of Recommenders from Resellers (102) enabling connection between Customers from Resellers (101) and the Geographical Area #1 Network (6). Reseller #1 (7) also comprises a set of Reseller #1 Establishments, comprised of Reseller #1 Establishment #1 (103.1) to Reseller #1 Establishment #n (103.n) where #n can be any integer number.

In one embodiment of the invention, and similarly to Reseller #1 (7), Reseller #2 (8) comprises a set of Recommenders from the Reseller (102) enabling connection between Customers from Resellers (101) and the Geographical Area #1 Network (6). Reseller #2 (8) also comprises at least a Reseller #2 Establishment #2 (104.1).

And again, in one embodiment of the invention, and similarly to Reseller #1 (7) and Reseller #2 (8), Reseller #n (9) comprises a set of Recommenders from the Reseller (102) enabling connection between Customers from Resellers (101) and the Geographical Area #1 Network (6). Reseller #n (9) also comprises a Reseller #n Establishment #n (105.n). Being #n any number ranging from #1 up to any infinite number. Generically FIG. 1 represents a possible network architecture comprising WANs (Wide Area Networks), 3G, 4G, 5G technologies or any future evolutions of these technologies, Router, Switches, DSL or Optical Fiber, LANs (Local Area Networks), using Wi-Fi, cable Ethernet, Bluetooth, etc. In a nutshell, any technology available to carry information over the Internet, intranets, internets or any other kind of data network in a fast and reliable manner.

Additionally, it is comprised of any type of Communications and Computing Devices capable of communicating between themselves, either at the Service Offering Side or the Service Consumption Side.

In a possible embodiment of the current invention, as illustrated in FIG. 2, it comprises a set of functional layers, particularly Layer 1 (20) and Layer 2 (30). Layer 1 (1) comprises a Machine Learning Customer and Other Entities Categorization Engine (21) and/or a Timers (Given Times) Calculation Module (22) and/or an Entities (Resellers, Reseller Establishments, Resellers Staff, Resellers Customers, “Direct” Customers, Tour Operators, etc.) Notification Determination Module (23) and/or a Calculation of the Last Possible Date and the Best Common Date that a Premium Tour or Activity can Take Place Module (24). On the other hand, Layer 2 (30) comprises a Premium Tour or Activity Groups Auto-Organizing Module (31) and/or a Premium Tour or Activity Auto-Booking Module (32) and/or an Entities Benefits Calculation and Attribution Module (33).

In another possible embodiment of the current invention, as illustrated in FIG. 3, the workflow of the proposed process comprises a set of steps that enables to organize the groups of customers in private tours or activities. The step methods comprise an initial Creation of a Premium Tour or Activity by a Customer Group (40). The next step will be the Identification of what Entities to Notify Next and Notify Them (41) and the Determination and Starting of the Necessary Timers (42). Following, a step for Waiting for More Customer Groups to Join In (43) will be the flag to the next step Its Necessary to Notify More Entities (44). If so, then step Identification of what Entities to Notify Next (41) will be recalled, just like the following steps, mentioned earlier. If there is no need to make this repetition, the next step will be Premium Tour or Activity Has Enough Customers (45) which is followed by the Determine Best Day and Time to Book (46). Afterwards, one of two steps may occur, or a Common Day and Time is no Longer Available for Booking Notify All Parties and Refund (50) the user(s), or a Best Day and Time found, Premium Tour is Booked (47) step takes place, followed by a Calculate Credits to Refund and Reseller(s) benefits (48) step, and finally a Notify All Parties (49) that the Tour or Activity will take place step.

The Application Servers (1), this is where the “Core” Logic of the Computer programable software process distributed by several Ecosystem Software Components (servers, web, mobile, desktop, laptop, etc.) is located. This can be any kind of computing machine with enough computing power for the purpose and communications capabilities to the exterior world (its own network and other networks like the Internet). It can scale up to any number of load balanced pool of servers or server farms in any kind of load balanced distributed system.

The Database Servers (2) is where data of the previously referred Application Servers use is stored. It can be one or more Database Servers. It can be an Oracle DB, Postgresql, MySql, or any other technology as long as it serves its purpose. The Database Servers can be installed in any computing machine with enough computing power for the purpose and communications capabilities to the exterior world (its own network and/or other networks). In this particular case, the Database servers do not necessarily need to be accessible by the Internet. They may only require access from the Application Servers through an internet or intranet. The File Servers (3) are any computing machine used by the referred applications to store and distribute by the several Geographical Areas any files necessary either to the Application Servers in question, but specially necessary for the terminal or end user devices (smartphones, tablets, smartwatches, personal computers, laptops, desktops, etc.) that a user (a Customer, Reseller, Reseller Recommender or any other entity) may use to access Holiday Senses Ecosystem Software including and specially this Computer programable Software Process. Additionally, to main File Servers (3), its content can be replicated in computing machines of a CDN (Content Distribution Network) that provide files closer to the end users making file load time faster.

The Machine Learning (ML) Customer and Other Entities Categorization Engine(s) (4) uses Application, Database and File Servers, and can be installed in any computing machines with enough computing power for the purpose and communications capabilities to the exterior world (its network and other networks).

The Entities Determination and Notification is module which is configured to determine at each notification event (ex: Creation of a Premium Tour or Activity, expiration of a Timer also referred in Use Cases as “a given time”, or any other event we find relevant), the best entities to notify (ex: Customers, Reseller Establishments, Reseller Recommenders, etc.). It gathers the necessary information from the data or information made available by the Machine Learning Customer and Other Entities Categorization Engine Module and/or from the Databases serving the Applications in the Application Servers. For example, looking at the region the entity belongs to, the reseller the entity belongs to, and in case of “direct” Customers, whether he/she is active in an Area and willing to receive invitations, and so on. The full set of necessary data and information is undetermined at this time and will vary as this algorithm is enhanced and fine-tuned with time and with the enhancement and training of the Machine Learning Customer and Other Entities Categorization Engine Module.

The Timers Calculation is a module that based on the nature of the event that triggers it (ex: Creation of a Premium Tour or Activity in the system, expiration of a previous started timer, etc.) and based on the data about the environment that triggered it (ex: Geographical Area where the entities are located, the nature of the entity that created the Premium Tour or Activity, their data in the database server, their information provided by the Machine Learning Customer and Other Entities Categorization Engine Module-Customer, Customer Group, Reseller, Reseller Customer, or any other), along with the data gathered from the Tour or Activity attributes (ex: first and last possible dates and times to take place, number of Customers that already joined, Tour or Activity creation date, etc.) can infer or calculate the best moment to expire and trigger the next entities to notify (the value of the timer in minutes, seconds, hours or days). Here, also the set of data necessary for the best functioning of this module is not strictly defined and must be evaluated along with its test and production results as well as the Machine Learning Customer and Other Entities Categorization Engine enhancement.

The Best Common Date and Time and/or the Last Possible Date and Time for the Premium Tour or Activity to Take Place is a module that whenever a new Customer Creates or Joins a Premium Tour or Activity determines from the data inserted by all Customers, and checking against the availabilities for that Tour or Activity, the days and times that that Tour or Activity can take place for the biggest set of Customers of that Premium Tour or Activity. Since each Customer has their own set of days and times that they are available to Experience the Premium Tour or Activity, the best and largest possible Set of Days and Times must be determined in order to Book the best Day and Time for the best and/or largest possible number of participants to Join the Tour or Activity.

If the first or some subsequent possible dates and times for given Premium Tour or Activity to take place has passed and not enough Customers have Joined it, it is also necessary to determine until when it is viable to wait for further Customers to Join and still have a successful Booking of the Premium Tour or Activity.

The Machine Learning Customer and other Entities Categorization Engine(s) Module enables categorizing the several entities that communicate amongst themselves and with the Computer-programable software Process being claimed, according to a set of data collected and present in the Database Server(s) and prepared according to Data Engineering Methods. This categorization of entities is achieved by treating and processing this data using several ML techniques. Entities are ranked in a way that they are easily interpreted and used by other software modules like the Entities Determination and Notification Software Module or Timers Calculation Module.

For example, Customer Rankings can be built on the data on previous Customer Purchase, Browsing History, Products or Services Reserved but not Booked, Products or Services that were marked as Favorites at some point in time, those Products or Services Contents and Attributes, all this in a Collaborative way amongst the Ecosystem Software users. From users we mean any Entity interacting with Ecosystem Software (normally a human being but can also be another Software Program Entity). The goal can be for example to determine the probability of a certain user to Join a given Premium Tour or Activity.

Also, the similarity of different Tours or Activities can be inferred (ex: by inferring the similarity of their contents like, title, description, photos, popularity, categories they fit in, Tour Operator/Provider, Tour Guide, etc.). The goal would be for example to build a ranking of Premium Tours or Activities each user would have high probability to join.

Similarly, other entities can be categorized in similar ways. For example, Resellers and their Establishments can be categorized according to their nature, Premium Tours or Activities they have higher probability of selling, the probability of selling only amongst their own customers or if they need the cooperation of other Reseller Establishments and which ones to “close” a Premium Tour or Activity. The possibilities here are endless. For example, it can be taken in consideration also the Reseller and/or their Establishments Recommenders, also the Tour or Activities providers, categories of their Tours and/or Activities, etc.

The Machine Learning Engine(s) described here is (are) intended to be used mainly for the purpose of increasing the probability of “closing” the Premium Tours or Activities by better addressing the Customers or Customer Groups acquired directly or by Resellers that increase the chance of a successful Booking in the shortest time possible, and not for any other generic purpose. But if any other use that suits this Computer programable software process is found the ML Categorization Engine(s) will be used for that purpose too. Data Manipulation techniques like, but not limited to, Similarity Measures (Euclidean Distance, Pearson Correlation, Cosine Similarity, etc.) can be used. Along with Clustering Techniques like but not limited to, K-means Clustering, Spectral Clustering, Co-clustering, etc. In the same way Dimensionality Reduction techniques can be used, like but not limited to, Principal Component Analysis, Linear-discriminant Analysis, Singular Value Decomposition, etc. These fall under Unsupervised Learning.

An option can be taken by Supervised Learning, using for example K-nearest Neighbors, or even more complex algorithms. Additionally, algorithms of Classification, Ensembling and Boosting techniques can also be used.

More could be said on this, but the criteria of which Algorithms and Machine Learning Techniques to use are not fully analyzed yet. This analysis will be done as the Holiday Senses Ecosystem gathers in its Databases the proper and enough data for use in the categorization of the several entities.

A Premium Tour or Activity Auto Booking Module automates the Booking Process of any Premium Tour or Activity in the Ecosystem. Having the Premium Tour or Activity been evaluated for a Successful Booking (ex. Having enough Customers with common date(s) and time(s)), then the best Day and Time for the Booking of the referred Premium Tour or Activity to take place is determined and the Tour or Activity is Booked for that Day and Time. If meanwhile that initial Booking Day and Time has already been taken by another tour created by the Holiday Senses ecosystem or not, then the algorithm of this module moves to the next possible Date and Time and so on until it finds the first available Date and Time by the time of Booking.

Entities Benefits Calculation and Attribution Software Module when a Premium Tour or Activity is finally Booked, or in the event of Subsequent Customers joining in, determines all its Customers and Customer Groups that became “harmed” by for example being the earliest to Book (create or join) and pay ending up paying more per person than the final calculated price per person when the Premium Tour or Activity places are closed. This difference in the paid value must be somehow compensated to the “harmed” Customers. This can be attributed in credits for further use in the Ecosystem like another Tour or Activity, or for example in any additional services a Reseller may offer, or any other use that may appear during Business Development (ex: Credits to spend in partnering shops or other establishments in the Tourism Area the Customer is visiting). Of course it cannot be neglected the obvious compensation, this is a refund of the extra amount paid directly to the Customer bank account using the payment method he/she used.

It is also important to set that the total refund of the paid amount to the Customer(s) bank accounts shall be done using the payment method used by them. This shall only occur if a Premium Tour or Activity does not take place for any reason (ex: minimum number of people not reached in time or bad weather conditions, etc.). These two aspects of the claim are crucial for the Business in order to increase the confidence and satisfaction of the Customers in the service described.

The calculation of benefits for the Resellers and Reseller Establishments is implemented in a Computer-programmable software method. These can result from direct sales made through these entities and are attributed to them according to and regulated by an agreement by both parties. Or can result from subsequent purchases of a customer “acquired” by that Reseller or Reseller Establishment, this is the LifeTime Value benefit referred previously. This benefit calculation and attribution is also implemented in a Computer-programmable software method and regulated by an agreement by both parties.

Finally, the Reseller Establishment Recommenders sales are also tracked by a Computer-programmable software method, and the benefits to attribute to the Reseller Establishment Recommenders informed to the Reseller Establishment. These benefits may or may be not subject to an agreement between the proprietary of the software and the Reseller or Reseller Establishment. So, in the later case, it is up to the Reseller or Reseller Establishment to attribute them to their Recommenders (chosen contact people).

The herein proposed computer implemented process to generate groups of users for shared private tours or activities, in one of the proposed embodiments of the invention, may be implemented using one or more processing units, one or more processing devices, any means for processing, such as a processor, a computer or a programmable hardware component being operable with accordingly adapted software. In other words, the herein described process is then executed on one or more programmable hardware components. Such hardware components may comprise a general-purpose processor, a Digital Signal Processor (DSP), a micro-controller, etc.

1. A computer-implemented process to organize groups of customers in private tours or activities comprising the steps of:
receiving a request (40) from a customer group to create a premium tour or activity in an area or region;
identifying entities to notify (41) next in a creation process of tours and activities and notify them;
determining and initiating necessary timers (42) to facilitate the creation process;
waiting for additional customer groups (43) to join in to meet participation threshold;
notifying additional entities (44) as needed so that the premium tour or activity gains sufficient participants (45);
determining an optimal day and time for booking (46) the premium tour or activity;
conducting the premium tour or activity (47) at the scheduled optimal day and time, or if a common day and time is no longer available, notifying all parties and initiating refund processes (50);
calculating credits to Refund (48) in the event eventual different prices per person are paid by the different groups that joined and the Reseller(s) benefits; and
notifying all involved parties of successful scheduling of the Premium Tour or Activity (49), and initiating refund processes as necessary.

2. The computer-implemented process to organize groups of customers in private tours or activities according to claim 1, wherein the entities are selected from the group consisting of: Resellers, Resellers Establishments, Resellers Recommendation Staff, Reseller Customers, Tour Operators and “direct” Customers using a company direct brand website, and/or Applications and/or Apps Software.

3. The computer-implemented process to organize groups of customers in private tours or activities according to claim 1, wherein an area or region comprising a set of Geographical Area Networks comprises Geographical Area #1 Network (6) and/or Geographical Area #2 Network (12) and/or Geographical Area #3 Network (13) up to and/or Geographical Area #n Network (14), wherein #n represents an infinites number of possibilities.

4. The computer-implemented process to organize groups of customers in private tours or activities according to claim 3, wherein a Geographical Area Network of the set of Geographical Area Network comprises a set of Resellers, Reseller Establishments, Resellers Recommenders, Reseller Customers, Tour Operators and Area “direct” Customers.

5. The computer-implemented process to organize groups of customers in private tours or activities according to claim 2, wherein the Resellers comprise at least one Reseller establishment, one Recommender from Resellers (102) linked to Customers from Resellers (101) and up to an infinite range of #n Reseller Establishments (103.n) and #n Recommenders from Resellers (102).

6. The computer-implemented process to organize groups of customers in private tours or activities according to claim 1, wherein the process is implemented locally and/or remotely over the Internet or over an internet network (5) which is connected to the set of Geographical Area Networks and which comprises Application Servers (1) and/or Database Servers (2) and/or File Servers (3) and/or Machine Learning (ML) Recommendation Engine(s) And Machine Learning (ML) Customer and Other Entities Categorization Engine(s) (4).

7. The computer-implemented process to organize groups of customers in private tours or activities according to claim 1, wherein the process implemented is spread up locally and/or remotely over several networks which are connected between themselves through the Internet and/or one or more internets and connected through the Internet and/or internets to the set of Geographical Area Networks, which comprises Application Servers and/or Database Servers and/or File Servers and/or Machine Learning (ML) Recommendation System Engine(s) And Customer and other Entities Categorization Engine(s).

8. A data processing system comprising the physical means necessary for the execution of the computer-implemented system and computer-implemented process described in claim 1.

9. A computer program comprising programming code or instructions suitable for carrying out the computer-implemented process described in claim 1, wherein said computer program is stored, and is executed in one or more data processing systems, remote or in-site, performing the respective steps described in claim 1 or distributed between one or more servers and personal computing devices.

10. A non-transitory computer-readable medium storing a programming code or instructions that implement the process according to claim 1.
